(19) United States
(12) Patent Application Publication
(10) Pub. No.: US 2010/0116038 A1
(43) Pub. Date: May 13, 2010

(54) FEEDBACK- ENHANCED THERMO-ELECTRIC TOPOGRAPHY SENSING

(75) Inventors: Peter Baechtold, Gattikon (CH); Abu Sebastian, Adliswil (CH); Dorothea W. Wiesmann Rothuizen, Adliswil (CH)

Correspondence Address: DUKE W. YEE;YEE & ASSOCIATES, P.C., P.O. BOX 802333, DALLAS, TX, 75380, US

(73) Assignee: International Business Machines Corporation, Armonk, NY (US)

(21) Appl. No.: 12/269,249

(22) Filed: Nov. 12, 2008

(51) Int. Cl. G01B 5/28; G01N 13/10

(52) U.S. Cl. 73/105; 850/5

(57) ABSTRACT

A method is provided for determining the topography of an object. A micro-cantilever with a scanning tip is provided. The micro-cantilever includes a thermal sensor. A biased voltage is applied across the thermal sensor. A resistance change of the thermal sensor is then identified. The bias voltage is then modulated, based on the resistance change to enhance the bandwidth and the sensitivity of the thermal sensor. Responsive to the scanning tip traversing a topographical variation on an object, the thermal sensor is vertically displaced with respect to the object, which induces a temperature change of the thermal sensor. A subsequent electrical resistance change of the thermal sensor is then identified, the subsequent electrical resistance change corresponding to a subsequent temperature change. The position of the object relative to the thermal sensor is then identified based on a difference between the initial electrical resistance and the subsequent electrical resistance. The topography of the object can then be determined based on the position of the object relative to the thermal sensor.

### BACKGROUND OF THE INVENTION

1. Field of the Invention

The present invention relates generally to high-resolution position sensing. More specifically, the present invention relates to methods for high-resolution topographical sensing utilizing feedback-enhanced thermo-electric position sensors.

2. Description of the Related Art

High-resolution topography sensing is a significant enabling technology for nanotechnology applications. Micro-fabricated silicon cantilevers with integrated heating elements serve as low-cost, easy-to-integrate topography sensors. The use of micro-heater sensor enabled silicon cantilevers has recently been introduced as an effective method of sensing topography. These sensor-enabled silicon cantilevers are very low-cost. This economic viability and ease of implementation make micro-heater sensors attractive for a variety of applications like low-cost scanning probe microscopy, nanolithography, as well as surface manipulation and investigation at the nanoscale. Thermo-electric position sensors have been shown to provide resolutions of less than a nanometer over a sensing bandwidth of approximately 5 kHz.

However, the speed and bandwidth desirable for determining accurate topography measurements by thermal position sensing are bottlenecked while the system adjusts to a new equilibrium temperature. The heater can be thought of as a thermal volume. Equilibrating to a new temperature will necessarily take some amount of elapsed time. Accurate determinations of the position can therefore not be identified until after the system has come to its new thermal equilibrium.

### BRIEF SUMMARY OF THE INVENTION

A method is provided for determining the topography of an object. A micro-cantilever with a scanning tip is provided. The micro-cantilever includes a thermal sensor. A biased voltage is applied across the thermal sensor. A resistance change of the thermal sensor is then identified. The bias voltage is then modulated, based on the resistance change to enhance the bandwidth and the sensitivity of the thermal sensor. Responsive to the scanning tip traversing a topographical variation on an object, the thermal sensor is vertically displaced with respect to the object, which induces a temperature change of the thermal sensor. A subsequent electrical resistance change of the thermal sensor is then identified, the subsequent electrical resistance change corresponding to a subsequent temperature change. The position of the object relative to the thermal sensor is then identified based on a difference between the initial electrical resistance and the subsequent electrical resistance. The topography of the object can then be determined based on the position of the object relative to the thermal sensor.

### BRIEF DESCRIPTION OF THE SEVERAL VIEWS OF THE DRAWINGS

FIG. 1 is a schematic representation of a silicon cantilevered scanning device in which illustrative embodiments can be implemented;

FIG. 2 is a schematic representation of a micro-fabricated silicon cantilever tip with integrated heating elements;

FIG. 3 is a sensing configuration of thermal position sensors according to the prior art;

FIGS. 4a and 4b is a block diagram representation of a micro-heater constituting the thermal position sensor according to the prior art;

FIG. 5 is a feedback-enhanced sensing configuration of an illustrative embodiment;

FIG. 6 is a block diagram representation of a feedback-enhanced micro-heater constituting the thermal position sensor of an illustrative embodiment; and

FIG. 7 is a flowchart process for determining the topography of an object.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer-usable or computer-readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to wireless, wireline, optical fiber cable, radio frequency (RF), etc.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

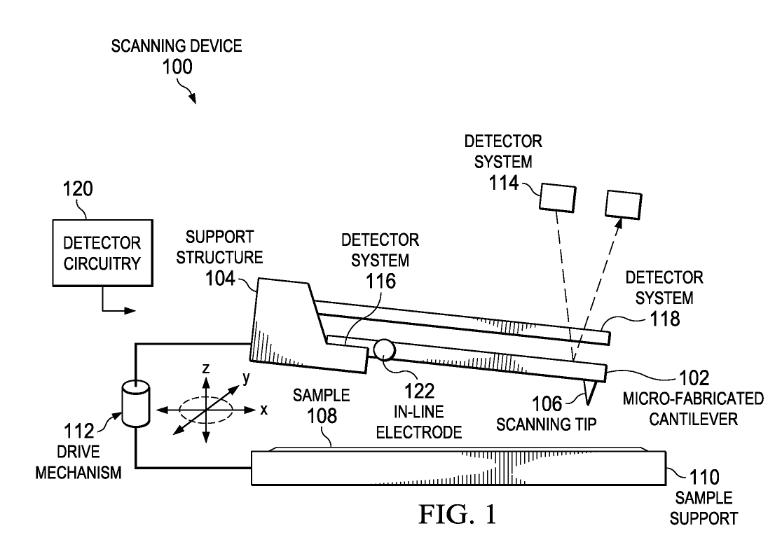

Referring now to FIG. 1, a schematic representation of a silicon cantilevered scanning device is shown in which illustrative embodiments can be implemented. Scanning device 100 comprises micro-fabricated cantilever 102 connected to support structure 104 for substantially pivotal movement about a pivot axis P, this movement being provided as before by flexing of the cantilever body.

Scanning tip 106 is disposed at the end of the cantilever, remote from support structure 104. In operation, sample 108 to be analyzed is placed on sample support 110. Drive mechanism 112 effects relative movement of scanning device 100 and sample support 110 such that the sample is scanned by scanning tip 106. During scanning, interaction of atomic forces between the tip and sample surface effects pivotal movement of micro-fabricated cantilever 102 due to the generally perpendicular movement of scanning tip 106. The topography of sample 108 is revealed by detecting this movement of scanning tip 106.

Three basic detector systems are indicated generally at 114, 116, and 118, though in practice, of course, only one of these systems is employed. Detector system 114 employs an optical technique, such as laser interferometry, to detect movement of the cantilever. Detector system 116 utilizes a piezoelectric sensor, which senses the stress caused by the pivotal deflection of the cantilever and is connected via the support to appropriate detector circuitry 120. Detector system 118 uses capacitive sensing, micro-fabricated cantilever 102 being employed as one electrode, which, together with in-line electrode 122 mounted above the cantilever, is again connected to appropriate detector circuitry 120. In-line electrode 122 thus serves as a proximity sensor for micro-fabricated cantilever 102, the distance between micro-fabricated cantilever 102 and in-line electrode 122, and hence the voltage drop detected by detector circuitry 120, varying with micro-fabricated cantilever 102 deflection caused by movement of scanning tip 106.

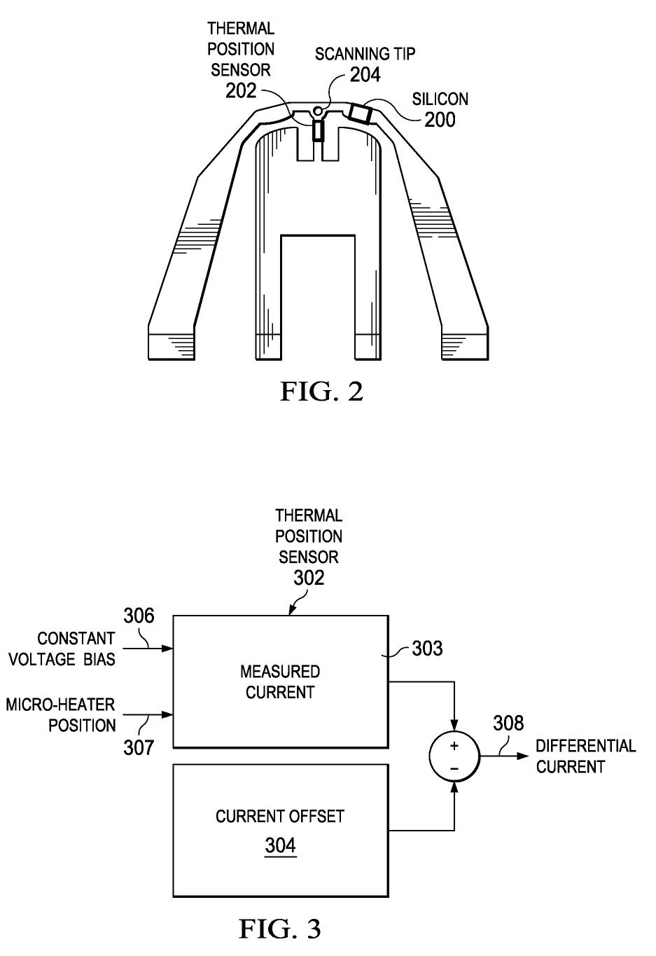

Referring now to FIG. 2, a schematic of a micro-fabricated silicon cantilever with integrated tip and heating elements is shown. Scanning tip 204 can be scanning tip 106 of FIG. 1.

Scanning micro-fabricated silicon cantilever 200 is comprised of thermal position sensor 202 that is used to provide topographical information of the underlying sample. Thermal position sensor 202 is positioned directly above the sample to be scanned. Thermal position sensor 202 is rigidly connect to scanning tip 204. Thermal position sensor 202 consists of at least one thermally-isolated resistive strip heater made from moderately doped silicon.

The thermoelectric topography sensing is based on two premises. First, the heat conduction through air depends on the distance of the sensor from the substrate. Second, the resistance of the heater is a strong function of the temperature.

As silicon cantilever 200 traverses an underlying sample with scanning tip 204 permanently in contact with said sample surface, local topography modulations scanned by scanning tip 204 translate into a change in the distance of thermal position sensor 202 from the substrate. This change in the distance results in a change in the temperature of thermal position sensor 202 and, thus, a change in the electrical resistance of thermal position sensor 202.

A method is provided for determining topography of an object. A micro-cantilever with a scanning tip is provided. The micro-cantilever includes a thermal sensor. A bias voltage is applied across the thermal sensor. A resistance change of the thermal sensor is then identified. The bias voltage is then modulated, based on the resistance change to enhance the bandwidth and the sensitivity of the thermal sensor. Responsive to the scanning tip traversing a topographical variation on an object, the thermal sensor is vertically displaced with respect to the object, which induces a temperature change of the thermal sensor. A subsequent electrical resistance change of the thermal sensor is then identified, the subsequent electrical resistance corresponding to a subsequent temperature. The position of the object relative to the thermal sensor is then identified based on a difference between the initial electrical resistance and the subsequent electrical resistance. The topography of the object can then be determined based on the position of the object relative to the thermal sensor.

Referring now to FIG. 3, a sensing configuration of thermal position sensor is shown according to the prior art. Thermal position sensor 302 is a thermal position sensor such as thermal position sensor 202 of FIG. 2. Thermal position sensor 302 traverses a sample substrate, such as sample 108 of FIG. 1.

When the scanning tip traverses the first topography on sample 108, the proximity of thermal position sensor 302 to the sample substrate will change relative to the topographical elevations of sample 108. Therefore, the proximity of thermal position sensor 302 to sample 108 may increase or decrease, depending on the topographical elevations of sample 108.

Constant voltage bias 306 is applied to thermal position sensors 302. Micro heater position 307 relative to the substrate changes the temperature and thus the electrical resistance of thermal position sensor 202 of FIG. 2 due to topography changes encountered by scanning tip 204 of FIG. 2, when scanning the sample substrate.

The change in proximity of thermal position sensor 302, resulting from topographical changes in the sample substrate, causes a change in the temperature of thermal position sensor 302. The change in temperature of thermal position sensor 302 affects a change in the electrical resistance of thermal position sensor 302. The measured current 303 through thermal position sensor 302 therefore changes. To isolate the current changes that correspond to the topography changes, the current offset 304 is subtracted. The current offset 304 is an initial current measured before sample scanning or an average current obtained through lowpass filtering of the signal current. The subtraction of current offset 304 from measured current 303 yields differential current 308. Differential current 308 can then be used as a measure of the position changes of the sample substrate relative to thermal position sensor 302.

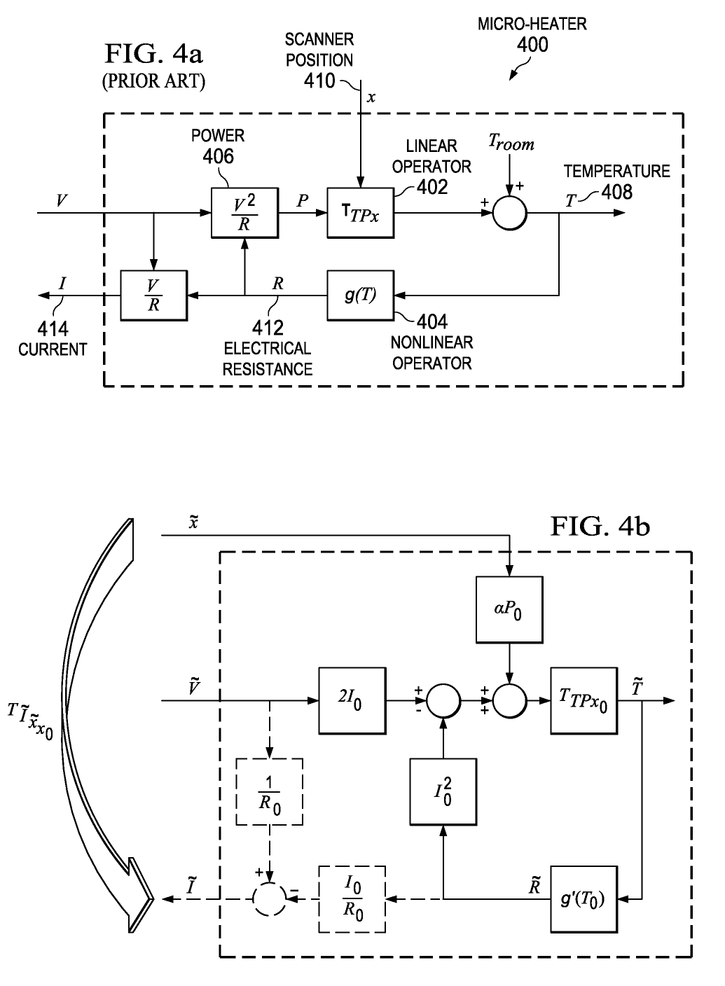

Referring now to FIG. 4a, a block diagram representation of a micro-heater constituting the thermal position sensor is shown according to the prior art. Micro-heater 400 can be thermal position sensor 202 of FIG. 2.

Micro-heater 400 is comprised linear operator 402 relating power with temperature, and nonlinear operator 404 relating the temperature with electrical resistance. Linear operator 402 relates input power 406 to temperature 408 utilizing a modeled function T_{TPx}. T_{TPx} captures the dynamics of thermal conduction as a function of the power dissipated in micro-heater 400 when scanner position 410 equals x.

Nonlinear operator 404 models the memoryless nonlinear relationship between temperature 408 and electrical resistance 412 as function g(T). g(T) is typically a bell-shaped curve with the resistance value reaching a maximum at a certain temperature Tₘₐₓ. Below Tₘₐₓ, electrical resistance 412 increases with temperature because of a corresponding decrease in the mobility of the majority carriers. However, above Tₘₐₓ, electrical resistance 412 becomes smaller with increasing temperature 408 owing to the predominance of the thermally activated increase of intrinsic carriers. The signal that could be measured experimentally is current 414, which is the input voltage divided by electrical resistance 412 of micro-heater 400.

FIG. 4b shows the linearized model of the micro-heater 400a, indicating the sensing transfer function of interest T_{Ĩ\tilde{x}x0}. The sensing transfer function T_{Ĩ\tilde{x}x0} relates the current changes Ĩ to the distance changes \tilde{x} around in average distance x₀ between the thermal position sensor and the sample substrate.

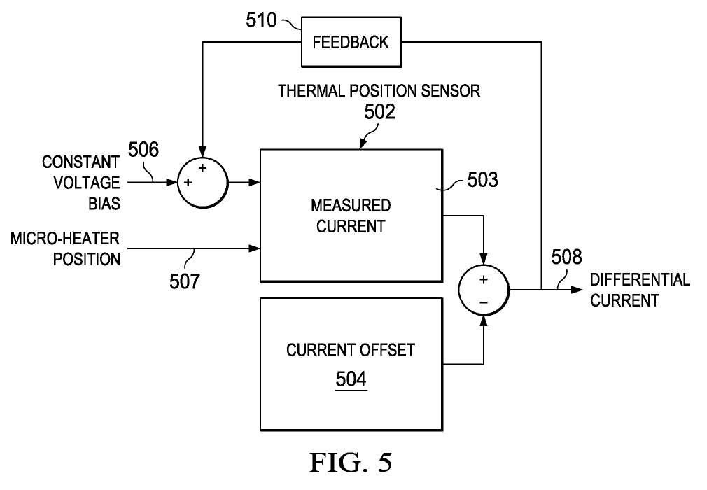

Referring now to FIG. 5, a feedback-enhanced sensing configuration of an illustrative embodiment is shown. Thermal position sensor 502 is a thermal position sensor such as thermal position sensor 202 of FIG. 2. Thermal position sensor 502 traverses a sample substrate, such as sample 108 of FIG. 1. When the scanning tip traverses the first topography on sample 108, the proximity of thermal position sensor 502 to the sample substrate will change relative to the topographical elevations of sample 108. Therefore, the proximity of thermal position sensor 502 to sample 108 may increase or decrease, depending on the topographical elevations of sample 108.

Constant voltage bias 506 is applied to thermal position sensor 502. Micro heater position 507 relative to the substrate changes the temperature and thus the electrical resistance of thermal position sensor 202 of FIG. 2 due to topography changes encountered by scanning tip 204 of FIG. 2, when scanning the sample substrate.

The change in proximity of thermal position sensor 502 resulting from topographical changes in the sample substrate causes a change in the temperature of thermal position sensor 502. The change in temperature of thermal position sensor 502 affects a change in the electrical resistance of thermal position sensor 502. Measured current 503 through thermal position sensor 502 therefore changes, as does differential current 508, after subtracting current offset 504. Differential current 508 can then be used as a measure of the position changes of the sample substrate relative to thermal position sensor 502.

Differential current 508 is fed back into constant voltage bias 506, via feedback 510, to modulate constant voltage bias 506. The differential current 508 is therefore used to “shape” the sensing transfer function T_{Ĩ\tilde{x}x0} of FIG. 4a.

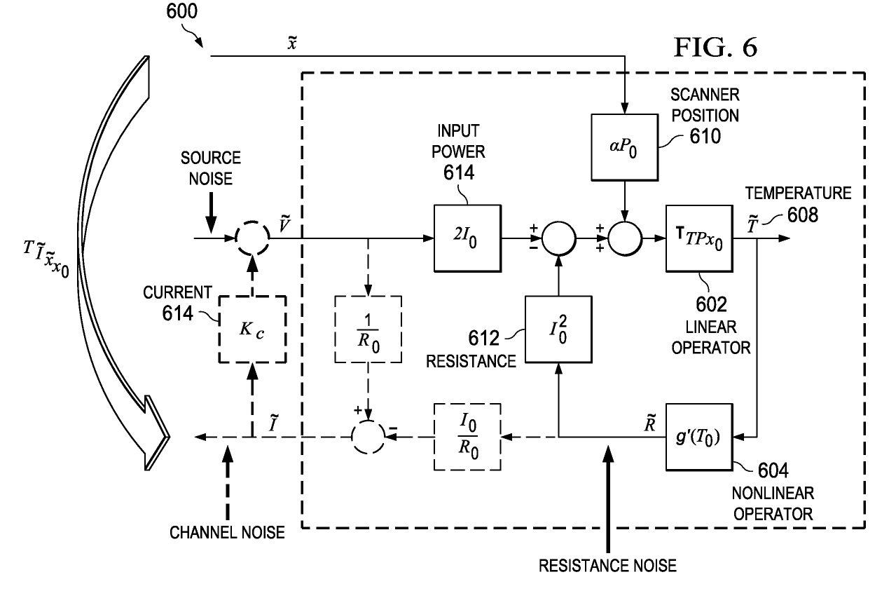

The feedback of differential current 508 also shapes the sensing transfer function T_{Ĩ\tilde{x}x0} of FIG. 4a, resulting in an increased bandwidth of the position sensor. Furthermore, resolution is increased as well where the dominant noise source is the channel noise (green in FIG. 6).

Referring now to FIG. 6, a block diagram representation of a feedback-enhanced micro-heater constituting the thermal position sensor. Micro-heater 600 can be thermal position sensor 202 of FIG. 2.

Micro-heater 600 is comprised of linear operator 602 relating power with temperature, and nonlinear operator 604 relating the temperature with electrical resistance. Linear operator 602 relates input power 606 to temperature 608 utilizing a modeled function T_{TPx}. Input power 606 is feedback modulated with current 614. T_{TPx} captures the dynamics of thermal conduction as a function of the power dissipated in micro-heater 600 when scanner position 610 equals x.

Nonlinear operator 604 models the memoryless nonlinear relationship between temperature 608 and electrical resistance 612 as function g(T). g(T) is typically a bell-shaped curve with the resistance value reaching a maximum at a certain temperature Tₘₐₓ. Below Tₘₐₓ, electrical resistance 612 increases with temperature because of a corresponding decrease in the mobility of the majority carriers. However, above Tₘₐₓ, electrical resistance 612 becomes smaller with increasing temperature 608 owing to the predominance of the thermally-activated increase of intrinsic carriers. The signal that could be measured experimentally is current 614, which is the input voltage divided by electrical resistance 612 of micro-heater 600.

Current 614 is modulated back into input power 606. The feedback of differential current 614 also shapes sensing transfer function T_{Ĩ\tilde{x}x0} of FIG. 4a, resulting in an increased bandwidth of the position sensor. Furthermore, resolution of the position sensor is also increased.

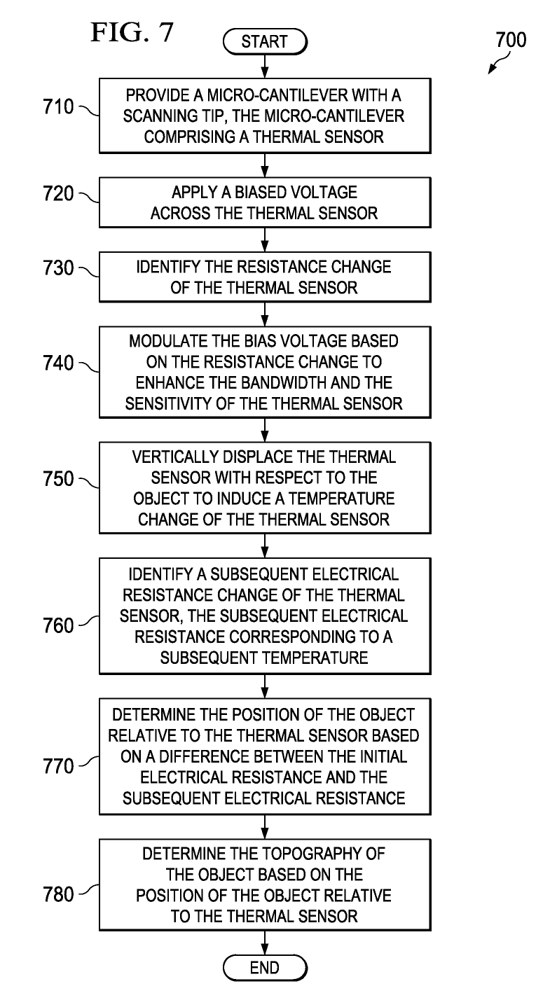

Referring now to FIG. 7, a process for determining the topography of an object is described. Process 700 determines the topography of an underlying sample substrate, such as sample 108 of FIG. 1. The scanning tip of a cantilevered silicon scanning device, such as scanning device 100 of FIG. 1, is provided with a feedback-enhanced micro-heater, such as micro-heater 600 of FIG. 6.

Process 700 begins by providing a micro-cantilever with a scanning tip, the micro-cantilever comprising a thermal sensor (step 710). The micro-cantilever can be micro-fabricated cantilever 102 of FIG. 1. The thermal sensor can be a feedback-enhanced micro-heater, such as micro-heater 600 of FIG. 6.

Process 700 then applies a bias voltage across the thermal sensor (step 720). By applying a constant voltage bias to the thermal sensor, any change in the displacement of the thermal sensor resulting from topographical changes of the underlying sample substrate causes a change in the temperature of the thermal sensor.

Process 700 then identifies the resistance change of the thermal sensor (step 730). The resulting resistance is an initial resistance to which subsequent changes can be compared.

Process 700 then modulates the bias voltage based on the resistance change to enhance the bandwidth and the sensitivity of the thermal sensor (step 740). The resulting current through the thermal position sensor is modulated back into the bias voltage applied to the thermal sensor. The feedback of the resulting current shapes the function relating distance changes to current changes, resulting in the increased bandwidth and sensitivity of the position sensor.

Responsive to the scanning tip traversing a topographical variation on the object, process 700 vertically displaces the thermal sensor with respect to the object to induce a temperature change of the thermal sensor (step 750). When the scanning tip traverses a topography, the proximity of the thermal sensor to the sample substrate may increase or decrease. The change in proximity of the thermal sensor resulting from topographical changes in the sample substrate causes a change in the temperature of the thermal sensor.

Responsive to the inducing temperature change of the thermal sensor, process 700 identifies a subsequent electrical resistance change of the thermal sensor, the subsequent electrical resistance change corresponding to a subsequent temperature change (step 760). The change in temperature of the thermal sensor affects a change in the electrical resistance of the thermal position sensors. This change in resistance can be identified by measuring the resulting current exiting the thermal sensor.

Process 700 then determines the position of the object relative to the thermal sensor based on a difference between the initial electrical resistance and the subsequent electrical resistance (step 770). By driving the sensor with a constant voltage, changes in resistance can be detected by measuring the resulting current. Process 700 can then determine the topography of the object based on the position of the object relative to the thermal sensor (step 780), with the process terminating thereafter.

Thus, the illustrative embodiments provide a method for determining the topography of an object. A micro-cantilever with a scanning tip is provided. The micro-cantilever includes a thermal sensor. A bias voltage is applied across the thermal sensor. A resistance change of the thermal sensor is then identified. The bias voltage is then modulated, based on the resistance change to enhance the bandwidth and the sensitivity of the thermal sensor. Responsive to the scanning tip traversing a topographical variation on an object, the thermal sensor is vertically displaced with respect to the object, which induces a temperature change of the thermal sensor. A subsequent electrical resistance change of the thermal sensor is then identified, the subsequent electrical resistance change corresponding to a subsequent temperature change. The position of the object relative to the thermal sensor is then identified based on a difference between the initial electrical resistance and the subsequent electrical resistance. The topography of the object can then be determined based on the position of the object relative to the thermal sensor.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/Output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of determining a topography of an object, the method comprising:
providing a micro-cantilever with a scanning tip, the micro-cantilever comprising a thermal sensor
applying a bias voltage across the thermal sensor;
identifying a resistance change of the thermal sensor;
modulating the bias voltage based on the resistance change to enhance a bandwidth and a sensitivity of the thermal sensor;
responsive to the scanning tip traversing a topographical variation on the object, vertically displacing the thermal sensor with respect to the object to induce a temperature change of the thermal sensor;
responsive to the inducing temperature change of the thermal sensor, identifying a subsequent electrical resistance change of the thermal sensor, the subsequent electrical resistance change corresponding to a subsequent temperature change;
determining a position of the object relative to the thermal sensor based on a difference between an initial electrical resistance and the subsequent electrical resistance; and
determining the topography of the object based on the position of the object relative to the thermal sensor.
